(19) United States
(12) Patent Application Publication
(10) Pub. No.: US 2026/0161446 A1
(43) Pub. Date: Jun. 11, 2026

(54) METHOD AND APPARATUS WITH ONLINE TASK PLANNING

(71) Applicant: Samsung Electronics Co., Ltd., Suwon-si (KR)

(72) Inventors: Junho CHO, Suwon-si (KR); Sung Hyun CHUNG, Suwon-si (KR); Inseop CHUNG, Suwon-si (KR); Kapje SUNG, Suwon-si (KR); Jinhyuk CHOI, Suwon-si (KR)

(73) Assignee: Samsung Electronics Co., Ltd., Suwon-si (KR)

(21) Appl. No.: 19/240,307

(22) Filed: Jun. 17, 2025

(30) Foreign Application Priority Data
Dec. 9, 2024 (KR) 10-2024-0181863

(51) Int. Cl. G06F 9/48

(52) U.S. Cl. CPC G06F 9/4881

(57) ABSTRACT

A processor-implemented method including analyzing an environment state responsive to an input and receiving streaming data, generating a task policy in response to the input and the analyzing of the environment state, monitoring a state of the task being performed according to the task policy to output tokens indicating the state of the task, and modifying the task policy based on the tokens, the task being performed according to the task policy as an overall task process by continuously collecting data generated while the task is in progress and continuously outputting tokens related to the state of the task from the monitoring.

### CROSS-REFERENCE TO RELATED APPLICATIONS

This application claims the benefit under 35 USC § 119(a) of Korean Patent Application No. 10-2024-0181863, filed on Dec. 9, 2024, in the Korean Intellectual Property Office, the entire disclosure of which is incorporated herein by reference for all purposes.

### BACKGROUND

### 1. Field

The disclosure relates to a method and an apparatus with online task planning.

### 2. Description of Related Art

Robot policies have been developed for navigation and manipulation tasks. In particular, low-level policies may be optimized for particular tasks and may exhibit excellent performance. For example, low-level policies may be highly efficient in tasks such as pick-and-place tasks, T-bar pushing, swinging movements, and balancing. These tasks may be performed through optimized algorithms that are suitable for the characteristics of each task, and representative policies may include reinforcement learning, diffusion policy, and vision-language action models.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided a processor-implemented method including analyzing an environment state responsive to an input and receiving streaming data, generating a task policy in response to the input and the analyzing of the environment state, monitoring a state of the task being performed according to the task policy to output tokens indicating the state of the task, and modifying the task policy based on the tokens, the task being performed according to the task policy as an overall task process by continuously collecting data generated while the task is in progress and continuously outputting tokens related to the state of the task from the monitoring.

The analyzing of the environment state may include outputting input tokens using a large language model (LLM) and one or more preprocessing models.

The outputting of the tokens indicating the state of the task may include outputting any one or any combination of a first output token indicating a task in progress state, a second output token indicating a task success state, and a third output token indicating a task failure state, through a multi-modal transformer.

The method may include, in response to the first output token being output, continuously monitoring the streaming data until meaningful progress on the task is observed.

The method may include, in response to the second output token being output, updating the task policy to establish a next task plan.

The method may include, in response to the third output token being output, analyzing a cause of failure and modifying the task policy based on the analyzing of the cause of failure.

The method may include, in response to the modifying of the task policy according to the cause of failure indicating that the task cannot be completed, transmitting a notification requesting additional instructions.

The modifying of the task policy may include performing reasoning and generating a low-level policy based on the tokens.

The preprocessing model may include a vision encoder configured to process any one or any combination of RGB, depth, and LIDAR data in the streaming data.

The performing of the overall task process may include analyzing a progress state of the task recursively and analyzing, in real time, a process for the progress of the task, a success of the task, and a failure of the task.

The modifying the task policy may include generating a new task policy based on the tokens, and the new task policy is created in response to one or more of detecting a task failure state, dynamic environmental changes, receiving override instructions, and optimizing task execution based on the continuously collecting of data.

In a general aspect, here is provided an electronic device including processors configured to execute instructions, a memory storing the instructions, and an execution of the instructions configures the processors to generate a task policy in response to an input and an analysis of an environmental state, monitor a state of a task performed according to the task policy to output tokens indicating the state of the task, and modify the task policy based on the tokens, the task being performed according to the task policy as an overall task process by continuously collecting data generated while the task is in progress and continuously outputting tokens related to the state of the task from the monitoring.

The processors may be further configured to output any one or any combination of a first output token indicating a task in progress state, a second output token indicating a task success state, and a third output token indicating a task failure state, through a multi-modal transformer.

The processors may be further configured to, in response to the first output token being output, continuously monitor the continuously collecting of data until meaningful progress on the task is observed.

The processors may be further configured to, in response to the second output token being output, update the task policy to establish a next task plan.

The processors may be further configured to, in response to the third output token being output, analyze a cause of failure and modifying the task policy based on the analysis result.

The processors may be further configured to, in response to the modifying of the task policy according to the cause of failure indicating that the failed task cannot be completed, transmitting a notification requesting additional instructions.

The token are outputting is performed by a large language model and one or more preprocessing models, and the one or more preprocessing models may include a vision encoder configured to process any one or any combination of RGB, depth, and LIDAR data in streaming data of the analysis of the environmental state.

The processors may be further configured to perform reasoning and generate a low-level policy based on the tokens.

The modifying the task policy further may include generating a new task policy based on the tokens, and the new task policy is created in response to one or more of detecting a task failure state, dynamic environmental changes, receiving override instructions, and optimizing task execution based on the continuously collecting of data.

Other features and aspects will be apparent from the following detailed description, the drawings, and the claims.

### BRIEF DESCRIPTION OF THE DRAWINGS

FIG. 1 illustrates an example method of online task planning according to one or more embodiments.

FIG. 2 illustrates an example method with a real-time embodied agent according to one or more embodiments.

FIGS. 3 to 6 illustrate examples tokens of a real-time embodied agent according to one or more embodiments.

FIG. 7 illustrates an example electronic device according to one or more embodiments.

Throughout the drawings and the detailed description, unless otherwise described or provided, the same or like drawing reference numerals may be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

The examples may relate to technologies that utilize streaming data to interact with environments and users in real time and perform complex tasks effectively.

Robot policies may be structured to focus on navigation and manipulation tasks. Among the robot policies, low-level policies may have the characteristic of being able to exhibit high performance through algorithms optimized for particular tasks, and are thus typical components of in robot systems.

For example, low-level policies may be highly efficient in tasks such as pick-and-place tasks, T-bar pushing, swinging movements, and balancing. These tasks may be performed through optimized algorithms that are suitable for the characteristics of each task, and various policies such as reinforcement learning, diffusion policy, and vision-language action models may be utilized.

Reinforcement learning may effectively solve complex tasks by learning reward functions while an agent (e.g., a robot) interacts with a simulation environment. Diffusion policy may naturally generate continuous action sequences, enabling flexible action generation in various situations. In addition, vision-language action models may naturally convey instructions to an agent by combining visual information and language information, and may have strengths in common sense reasoning and spatial reasoning.

In order to improve the practicality of robots, an ability to perform long-horizon tasks that may achieve long-term goals beyond simply performing short-term tasks may be desired. The low-level policies described above may effectively contribute to solving these complex long-horizon tasks when implemented sequentially and in combination.

For example, a complex long-horizon task such as “cooking roasted carrots” may be an example of a practical task that a robot should be able to perform. Assuming a kitchen environment is available with access to carrots, a sink, and a frying pan, etc., this task may be composed of the following several sub-tasks: i) Go to the kitchen and prepare the target task; ii) Wash the carrots in the sink; iii) Peel the carrots; iv) Place the pan on the stove; v) Turn on the heat and preheat the pan; vi).

A robot that may successfully perform such multi-step tasks may be practically utilized in a variety of real-world environments.

Recently, an advanced form of an embodied agent (e.g., a robot) based on a large language model (LLM) is under development and may solve these types of long-horizon tasks. For example, LLMs may perform common sense reasoning based on vast knowledge and may systematically plan complex tasks by dividing the tasks into several sub-tasks. In addition, LLMs may utilize low-level policies appropriate to the situation and cooperate with users through smooth communication to achieve given goals.

For example, in a task such as “cooking roasted carrots,” a user may ask an LLM such as GPT-4 to guide the user through a detailed recipe process and step-by-step instructions. The LLM may have the intelligence to plan sub-tasks to solve such tasks, but the LLM may have to be connected to a physical device to operate in an embodied form in the real physical world.

For LLMs to operate robots in real-world environments, a real-time interaction with the environment and users may be required. LLMs are already capable of advanced reasoning and common sense reasoning, and there is potential for continued improvement. However, LLMs may have difficulty with real-time interactivity, immediate communication with users in a physical environment, and adaptation to environmental changes. By reinforcing these real-time interaction capabilities, LLM-based robots may perform more practical roles and actions.

The following examples may relate to a real-time embodied agent that performs online task planning and generates and executes policies by interacting with the environment and users in real time based on streaming data (e.g., camera RGB, depth, lidar, etc.).

In the described examples, an embodied agent (e.g., a robot) may be referred to as an electronic device, which may be a robot, an autonomous vehicle, or other automated system capable of performing physical tasks that may operate in a real-world environment.

For example, a robot may detect an object in its work environment, move based on the object's location, and perform a particular action. In the case of an autonomous vehicle, data from the road and surrounding environment may be processed to plan an optimal route and drive safely. These types of electronic devices may perform a variety of complex tasks through functions such as real-time processing of streaming data, policy generation and execution, and task state determination.

The concept of an agent used in the described examples may be applied not only to tasks in a physical environment but also to tasks in a virtual environment, and may be expanded to be used in various industries and application fields.

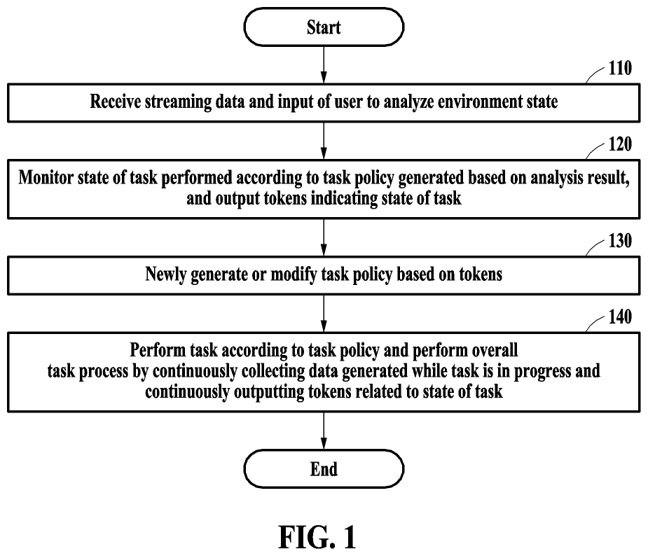

FIG. 1 illustrates an example method of online task planning according to one or more embodiments.

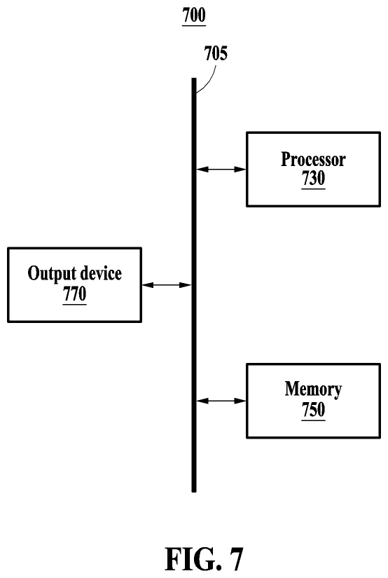

For ease of description, operations 110 to 140 are described as being performed using an electronic device 700 illustrated below in FIG. 7. However, operations 110 to 140 may be performed by another suitable electronic device in a suitable system.

Furthermore, the operations of FIG. 1 may be performed in the shown order and manner. However, the order of some operations may be changed, or some operations may be omitted, without departing from the spirit and scope of the shown example. The operations shown in FIG. 1 may be performed in parallel or simultaneously.

Referring to FIG. 1, in a non-limiting example, in operation 110, an electronic device (e.g., electronic device 700) may receive streaming data and an input, such as a user's input, to analyze an environment state. The input may include an initial instruction input to an LLM for a task or an override instruction instructed during a task of the electronic device. The streaming data may be a continuous flow of data generated from a camera, a LIDAR sensor, a depth sensor, or the like. This data is processed in real-time and may continuously observe or analyze the state of the environment. The streaming data may be generally input at high speed and may require immediate response and processing.

For example, the user may instruct (i.e., provide an input for) a robot to start a task, “Cook roasted carrots,” or may request a particular change during the task. In this example, the user may make an instruction such as “Wash the carrots first” or “Preheat the pan.”

In an example, the electronic device may output input tokens using an LLM and one or more preprocessing models.

For example, when the user gives the instruction “Cook roasted carrots,” the LLM may analyze the instruction to extract necessary sub-tasks, convert the instruction to an input token, and process the input token. The input token may be used as an instruction to perform tasks and may play a significant role in determining what actions the robot is to take.

The preprocessing model may include a vision encoder that may process any one or any combination of RGB, depth, and LIDAR data from the streaming data.

The vision encoder may be an artificial neural network (ANN) model that trained to process an image input from a camera to extract meaningful features.

For example, in the task, “Cook roasted carrots,” the robot may collect RGB data (color and shape information), depth data (distance information), and LIDAR data (three-dimensional (3D) spatial information) in real time to analyze the kitchen environment. The vision encoder may process this data in real time to help the robot determine the location of the carrot and identify the location of the sink or pan.

In an example, in operation 120, an electronic device (e.g., electronic device 700) may monitor the state of the task performed according to a task policy generated based on the analysis result, and output tokens indicating the state of the task. The electronic device may continuously monitor the state of the task performed according to the generated task policy, and output tokens indicating the state of the task. For example, in the task, “Cook roasted carrots,” the electronic device may generate an output token indicating an appropriate state depending on whether the task is currently in progress, successful, or failed.

In an example, a token may be a digital unit of information that represents a state or process of a task. The token may define the progress, success, or failure of a task, and based on this information, the token may determine the next task step of the system.

The task policy may be a set of action guidelines to achieve a particular task or goal. The policy may change depending on the situation based on the input data and may include a set of instructions required to perform a task. For example, when a robot performs the task of picking up and moving an object, a policy may be established that includes a “grab object action” and a “move to a target point action.”

For example, the electronic device may output any one or any combination of a first output token indicating a task in progress state, a second output token indicating a task success state, and a third output token indicating a task failure state through a multi-modal transformer. For example, when a robot performs the task of washing carrots, the first output token may be generated when the task is started and progressing normally. When the task is successfully completed, the second output token may be output, and when the task fails because the carrot is not positioned correctly, the third output token may be output.

The multi-modal transformer may be defined as a type of machine learning model that analyzes the features of input data and generates an appropriate output based on the analyzed features. The multi-modal transformer may understand the context of continuous data and may be used in various fields such as natural language processing and vision data processing.

Multi-modal data input to the multi-modal transformer may be data containing different types of data simultaneously. For example, multi-modal data may include RGB image data, depth data, LIDAR data, and the like. The multi-modal data may perform more sophisticated analysis by comprehensively processing information obtained from each modality.

When the first output token is output, the electronic device may continuously monitor the streaming data until meaningful progress on the task is observed. For example, when the first output token is generated indicating that the “wash carrots” task is in progress, the robot may continuously monitor the state of the carrots and water through the streaming data and monitor whether the task is progressing successfully.

When the second output token is output, the electronic device may update the task policy to establish the next task plan. Here, the electronic device may transmit a task success notification to the user. For example, when the task of washing carrots is completed, the second output token may be generated, and the electronic device may update the plan with the next task “Peel carrots.” At the same time, the task success notification may be sent to the user, allowing the user to check the progress in real time.

When the third output token is output, the electronic device may analyze the cause of failure and generate or modify the task policy based on the analysis result. For example, when the task of washing carrots fails because water does not come out, the electronic device may analyze the cause of failure as lack of water and request the user to fill the sink with water or modify the task policy to use a different sink.

When generating or modifying the task policy according to the cause of failure is not possible, the electronic device may transmit a notification to the user requesting further instructions. For example, when the robot may no longer continue performing the task, the electronic device may transmit a notification such as “Please fill the sink with water” or “Should I stop the task and perform a different task?” to the user requesting further instructions.

In an example, in operation 130, the electronic device (e.g., electronic device) 700 may newly generate or modify the task policy based on the tokens. The output tokens indicating a task state may reflect the progress of a current task and may provide basic data for determining the next action to be performed by the electronic device. For example, in the task, “Cook roasted carrots,” when the third output token is generated indicating that the task has failed, the electronic device may analyze the cause of failure and establish a new policy to continue the task.

The electronic device may perform reasoning based on the tokens to generate a low-level policy. For example, when a particular condition is not satisfied while a task is in progress, the electronic device may evaluate the current state of the task and generate a new low-level policy based on the evaluation. The low-level policy may define particular actions at lower levels of a task, allowing the robot to perform detailed actions such as picking up or moving objects.

In an example, a multi-modal transformer may interpret the output tokens indicating the task state and perform reasoning based on such interpretation to generate an appropriate low-level policy. For example, in the task, “Cook roasted carrots,” when the third output token is generated indicating that the task of washing carrots has failed, the electronic device may infer the cause of failure as “The carrots are not placed in the correct location.” Based on this reasoning, the electronic device may generate a new low-level policy such as “Move the carrots to the correct location.”

In an example, the multi-modal transformer may be a device that includes a machine learning-based model that may process various forms of input data (e.g., video frames, user instructions, policy tokens, and the like) to evaluate a task state in real time, generate and modify policies, and control task execution.

The generated low-level policy may specifically define the actions of the electronic device and may be converted into executable tasks. For example, when the task, “Wash carrots” has failed, the electronic device may generate a policy, “Adjust the location of the carrots and wash them again.” These low-level policies may complement or modify existing task steps to increase the probability of success.

The electronic device may continuously monitor the task state while the task is in progress and may perform additional reasoning whenever a new output token is generated. For example, when the task of washing carrots is successful, the electronic device may generate a policy for the next task step, “Peel carrots.” Such continuous reasoning and policy modification may allow the overall flow of the tasks to be kept flexible and efficient.

When it is determined that the state or the cause of failure of a task requires user intervention during the reasoning and policy generation process, the electronic device may transmit a notification to the user and request additional instructions. For example, when the task, “Cook roasted carrots” is interrupted due to lack of water, the electronic device may notify the user of the issue by transmitting a notification, “Please fill the sink with water.”

As described above, the electronic device may perform reasoning based on the output tokens indicating the task state and generate and modify low-level policies to increase the probability of success of the task and maintain an efficient task flow.

In an example, in operation 140, the electronic device (e.g., electronic device 700) may perform a task according to the task policy and perform the overall task process by continuously collecting data generated while the task is in progress and continuously outputting tokens related to the state of the task. For example, in the task, “Cook roasted carrots,” the electronic device may initiate a task based on a user's instructions and analyze data generated at each step of the task to generate a status token.

The electronic device may analyze a progress state of the task recursively and analyze, in real time, a process for the progress of the task, the success of the task, and the failure of the task. An output token indicating the progress state of the task may be generated in conjunction with the task policy and current state data. For example, during a carrot washing task, a robot may continuously monitor the flow of water and the location of the carrots, and generate an “in progress” status token to indicate that the task is progressing successfully.

In an example, the overall task process described above may be carried out as described below. The user may convey a task instruction such as “Cook roasted carrots.” The electronic device may process LLM and multi-modal inputs based on the instruction to establish a task policy and determine an initial state required for performing the task. The initial state may be formed by collecting and analyzing environmental data within the kitchen as streaming data.

As the task progresses, the electronic device may continuously monitor the task state. When the task is progressing normally, a first output token indicating a task in progress state may be output, and the electronic device may continue to collect data to determine the next task state. When the task is successful, a second output token indicating a task success state may be output, and the electronic device may plan the next task based on the second output token. When a third output token indicating a task failure state is output, the electronic device may analyze the cause of failure and modify the task policy or request user intervention.

When the third output token indicating a task failure state is output, the electronic device may perform reasoning to identify the cause of failure and generate a new task policy. For example, when a frypan is not positioned correctly during a “preheat pan” step, the electronic device may detect this and generate a new policy, “Move the pan to the correct location.” When the task policy is updated, the electronic device may perform the task again and monitor the progress.

When the task is successful, the electronic device may generate the second output token indicating a task success state and notify that the task is successful to the user. For example, the electronic device may notify the user that the “Wash carrots” task has been completed and automatically proceed to the next task step, “Peel carrots”.

In certain situations during a task, the electronic device may interact with the user to request additional instructions. For example, when the robot does not recognize the carrots correctly during the task, “Cook roasted carrots,” the electronic device may transmit a request to the user such as “Please adjust the location of the carrots.”

The electronic device may automate the overall task flow through a continuous cycle of task policies, task state monitoring, reasoning, and policy updates. Even in exceptional situations such as task failure, the electronic device may autonomously modify the task and plan the next step. This flexibility may increase the accuracy and success rate of the task.

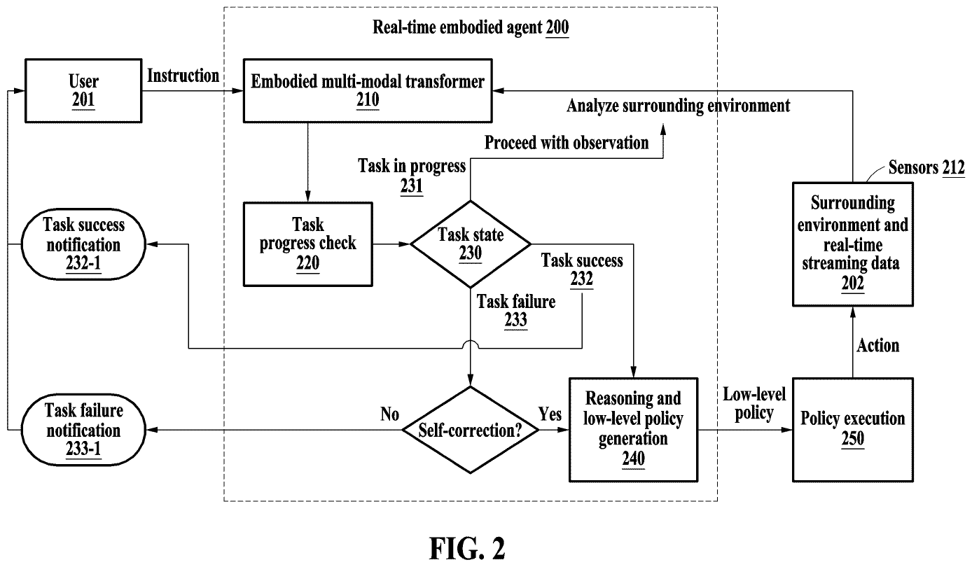

FIG. 2 illustrates an example method with a real-time embodied agent according to one or more embodiments.

The description referring to FIG. 1 may also be applied to FIG. 2, and a repeated discussion thereof may be omitted.

Referring to FIG. 2, in a non-limiting example, a real-time embodied agent 200 (e.g., the electronic device 700 of FIG. 7) may receive streaming data and an instruction from a user to perform a task, continuously monitor the state of the task, and modify a policy or complete the task depending on the state of the task.

The real-time embodied agent 200 may execute operations such as “user 201”, “embodied multi-modal transformer 210”, “task progress check 220”, “task state check 230”, “task in progress 231, task success 232, and task failure 233 output tokens”, “task success notification 232-1 and task failure notification 233-1”, “reasoning and low-level policy generation 240”, “policy execution 250”, “surrounding environment and real-time streaming data 202” and the like, and operate by organically interacting with the user 201.

The user 201 may transfer a task instruction such as “Cook roasted carrots” to the real-time embodied agent 200. The instruction from the user 201 may be used to establish an initial task plan and may be converted into a specific task policy via the real-time embodied agent 200.

The real-time streaming data 202 may be input through a sensor 212 (e.g., a camera, a LIDAR sensor, a depth sensor, or the like), and the real-time embodied agent 200 may analyze the current environment based on the real-time streaming data 202. For example, in the task, “Cook roasted carrots,” a robot may identify the location of the carrots through the real-time streaming data 202 and analyze the state of the sink and frypan. The real-time embodied agent 200 may process the real-time streaming data 202 through an analysis of the surrounding environment to determine the state of the task environment and plan necessary tasks.

In an example, the multi-modal transformer 210 may continuously monitor the task state 230 and may generate output tokens indicating states such as the task in progress 231, task success 232, and task failure 233. The embodied multi-modal transformer 210 may determine the task state 230 through the task progress check 220, and may proceed to the next step when the task succeeds 232 or instruct to analyze the cause of failure when the task fails 233.

For example, when a “Wash carrots” task is in progress, the real-time embodied agent 200 may monitor the location of the carrots and the flow of water to determine whether the task is being performed correctly. When the task is completed, the task success notification 232-1 may be generated and a “Peel carrots” task may be proceeded.

When the task failure 233 state is identified, the real-time embodied agent 200 may analyze the cause of failure and general a new policy or modify the existing policy. For example, when the frying pan is not positioned correctly during the “Preheat pan” task, the real-time embodied agent 200, in a case where self-correction is possible, may generate a new low-level policy such as “Adjust pan location” through the reasoning and low-level policy generation operation 240.

In a case where self-correction is not possible, the real-time embodied agent 200 may transmit the task failure notification 233-1 to the user and request additional instructions. For example, a notification such as “There is no water in the sink. Please fill it with water.” may be transmitted to the user.

When a low-level policy is generated, the real-time embodied agent 200 may perform a task based on the generated low-level policy. The real-time embodied agent 200 may control the detailed operations of the robot through the policy execution 250 and may perform all steps necessary to successfully complete a task. For example, in the “Wash carrots” task, the robot may perform the task by placing the carrots in the correct location and using water appropriately.

When the task is successfully completed, the real-time embodied agent 200 may transmit the task success notification 232-1 to the user and continue the task to the next step (e.g., the reasoning and low-level policy generation 240 for the next task).

The real-time embodied agent 200 may efficiently perform complex tasks such as “Cook roasted carrots” through continuous cycles of task state monitoring, task policy generation and modification, and task execution. Data generated during the task process may be continuously analyzed, and policies may be flexibly changed or interaction with the user 201 may be performed depending on the task state.

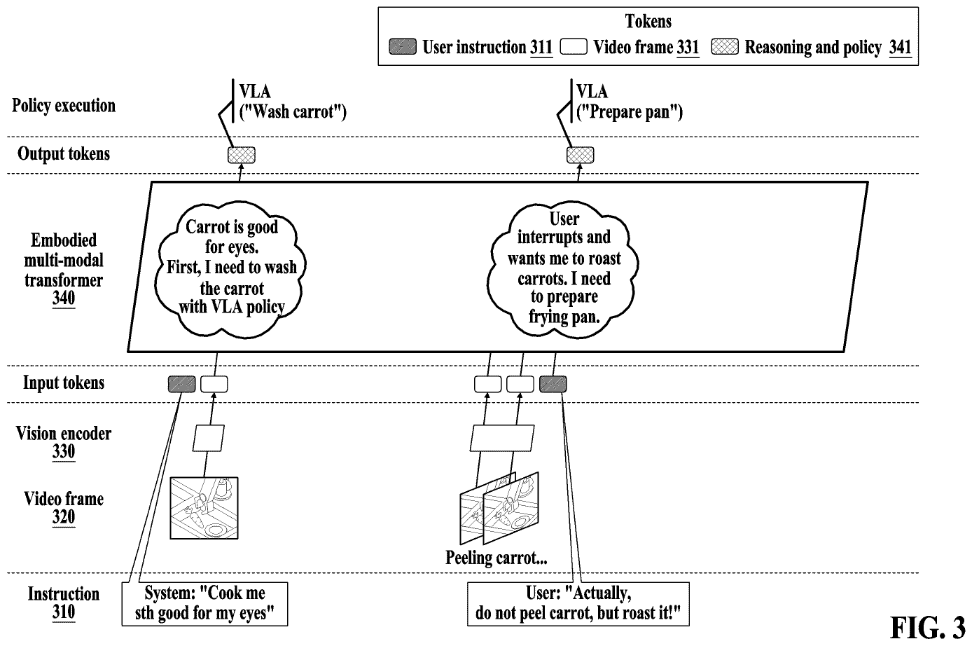

FIGS. 3 to 6 illustrate examples tokens of a real-time embodied agent according to one or more embodiments.

The description referring to FIGS. 1 and 2 may also be applied to FIGS. 3 to 6, and a repeated discussion thereof may be omitted.

In an example, input tokens may include user instruction tokens 311, video frame tokens 331, and reasoning and policy tokens 341. The user instruction tokens 311 may be a tokenized user instruction input to an LLM. The video frame tokens 331 may be tokenized streaming data (e.g., a video frame 320) through a vision encoder 330. The reasoning and policy tokens 341 may be tokens generated based on input tokens.

Referring to FIG. 3, in a non-limiting example, an initial task process may include a process in which a real-time embodied (e.g., the real-time embodied agent 200) converts user input and streaming data into tokens to perform reasoning and task policy generation.

The input tokens may include the user instruction tokens 311, video frame tokens 331, and reasoning and policy tokens 341. The user instruction tokens 311 may be a tokenized user instruction input to an LLM and may include information related to an initial goal of a task. For example, when a user instructs the task, “Cook roasted carrots,” the instruction may be analyzed by the LLM and converted into the user instruction tokens 311 including detailed task information such as “Wash carrots”, “Preheat pan”, and “Cook carrots”.

The video frame tokens 331 may be tokenized streaming data through the vision encoder 330 and may provide information related to the task environment. For example, the video frame 320 captured by a camera in a kitchen environment may be processed in real time by the vision encoder 330 and converted into the video frame tokens 331 in which environmental factors such as “location of carrots”, “location of sink”, and “state of pan” are reflected.

The reasoning and policy tokens 341 may be tokens generated based on input tokens. Reasoning tokens may include information necessary to interpret the current task state and goals and determine the next action by combining the input user instructions with the video frame 320 data. For example, a task goal such as “Put the carrots in the sink” may be generated as a reasoning token.

Policy tokens may include executable action instructions generated based on reasoning results. For example, when a “Wash carrots” policy token is generated in the “Cook roasted carrots” task, a robot may perform the task of using water to wash the carrots according to the policy.

In an example, the real-time embodied agent may analyze the environment based on input tokens, continuously monitor the task state, and generate the reasoning and policy tokens 341. Before the task begins, the real-time embodied agent may determine an initial goal based on the user instruction tokens 311 and collect environmental information by analyzing the video frame tokens 331. The collected environmental information may be used for reasoning and policy generation and may be used as a preparatory step for performing the initial stages of the task.

For example, in the “Cook roasted carrots” task, the real-time embodied agent may analyze the user instruction tokens 311 in the initial stage to divide the task and establish initial goals such as “Locate carrots” and “Approach sink”. The real-time embodied agent 200 may receive the video frame tokens 331 as input, identify the locations of the carrots and sink, and generate a policy token such as “Move the carrots to the sink” to perform the task.

In FIG. 3, override instructions may represent a process in which the real-time embodied agent (e.g., real-time embodied 200) dynamically changes and adjusts a task flow through interaction with the user. This process may include the real-time embodied agent receiving new instructions from the user during a task, interrupting or adjusting a current task, and reflecting new goals.

While the task is set to “Cook roasted carrots,” the real-time embodied agent may perform sub-tasks such as “Peel carrots” according to the initial task plan. In this process, the real-time embodied agent may perform a low-level policy that executes “Peel carrots” based on the user instruction tokens 311 and the video frame tokens 331.

When a user gives a new instruction during a task, the real-time embodied agent may pause or stop the existing task and change the task flow according to the new instruction. In the example of FIG. 3, the user transfers an override instruction, “Actually, do not peel the carrot, but roast it!” This instruction may interrupt the existing “Peel carrots” task and shift the task goal to a new task, “Prepare frying pan and roast the carrots.”

The real-time embodied agent may receive the new instruction from the user, analyze the instruction, and generate a new policy token. For example, a new policy, “Prepare pan” may be generated to replace the existing task, “Peel carrots.” Here, the real-time embodied agent may use the LLM and streaming data to determine the location of the frying pan in the current environment and plan detailed actions necessary to prepare the frying pan.

After the new policy is established, the real-time embodied agent 200 may resume the task based on user instructions. For example, low-level policies such as “Check pan location”, “Move pan”, and “Preheat pan” for preparing a frying pan may be executed.

The real-time embodied agent that receives an override instruction may flexibly respond to a user's instructions and dynamically adjust tasks, rather than following a fixed task flow. Accordingly, when a user sets a new goal or changes an existing goal during a task, the real-time embodied agent may reflect the new goal or changes and perform the task more efficiently.

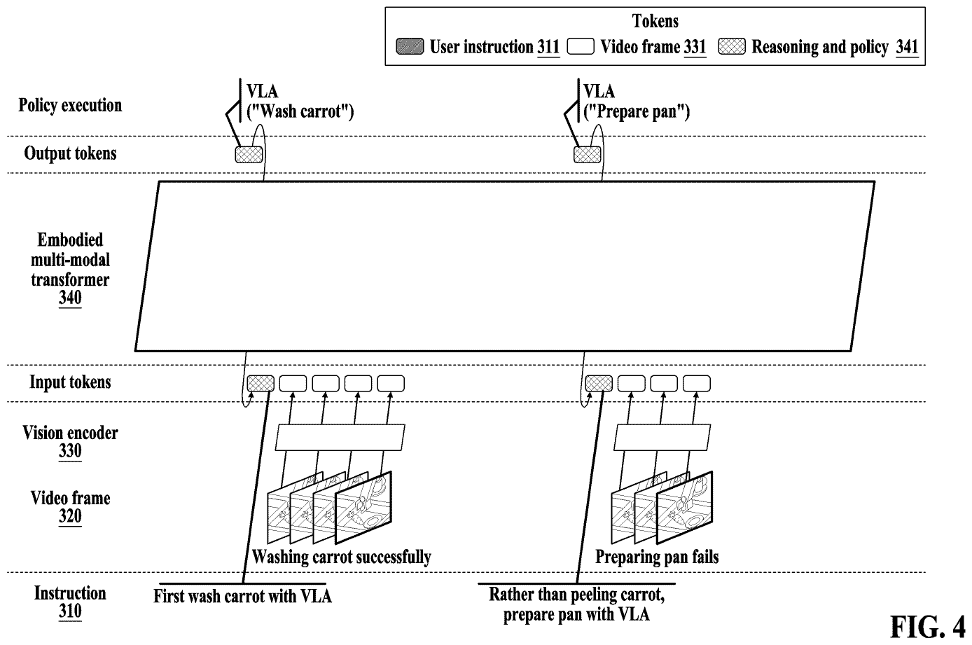

Referring to FIG. 4, in a non-limiting example, the reasoning and policy tokens 341 generated by the real-time embodied agent (e.g., real-time embodied 200) may be used as inputs to an embodied multi-modal transformer 340 in an auto-regressive manner together with streaming data observing an environment in which a policy is executed. The embodied multi-modal transformer 340 may observe the streaming data to determine whether a task is being performed according to the generated policy.

The real-time embodied agent may continuously examine a task state by combining the generated policy tokens with input tokens in an auto-regressive manner. Here, the streaming data may provide environmental information such as the video frame 320 in real time, and the real-time embodied agent may monitor whether a policy is being appropriately applied to the environment. For example, while a “Wash carrots” policy is being executed in a “Cook roasted carrots” task, the real-time embodied agent may use the embodied multi-modal transformer 340 to determine based on the streaming data whether the carrots are in the correct location and whether water is being used appropriately.

The streaming data may be processed through the vision encoder 330, through which the video frame 320 may be tokenized and converted into input tokens. For example, a scene in which the “Wash carrots” process is successfully being carried out in the video frame 320 may be converted into an input token and transferred to the embodied multi-modal transformer 340. The input tokens may reflect the state of the task in real time and may be combined with policy tokens to evaluate the suitability of task execution.

The embodied multi-modal transformer 340 may continuously examine the task state by analyzing the input tokens and policy tokens. For example, when the “Wash carrots” task is successfully performed, the embodied multi-modal transformer 340 may generate a token indicating a “task success” state. On the other hand, when a “Prepare pan” task fails, a token indicating a “task failure” state is generated, and the cause of the failure may be analyzed to take appropriate action. For example, a “Preparing pan fails” token as illustrated in FIG. 4 may indicate a failure state, and the real-time embodied agent may detect such failure state to generate a new policy.

When a task failure state is detected, the embodied multi-modal transformer 340 may perform reasoning to analyze the cause of failure and generate a new policy token based on the analysis. For example, when “Preparing pan fails” is detected, the system may generate a new policy token such as “Adjust pan location” or “Replace pan”. The generated policy tokens may be reused as auto-regressive inputs to resume the task.

The embodied multi-modal transformer 340 may continuously monitor the streaming data during policy execution and dynamically update the task state. For example, after the “Wash carrots” task is successfully completed, the embodied multi-modal transformer 340 may seamlessly switch to the “Peel carrots” task. Here, a new policy token may be generated, and the task state may be reevaluated through the streaming data.

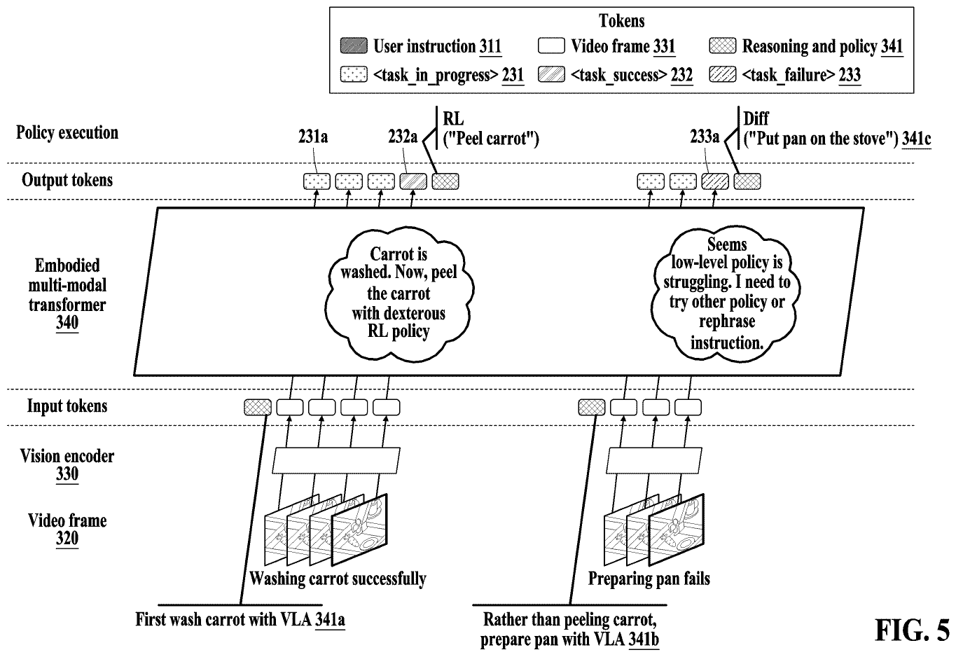

Referring to FIG. 5, in a non-limiting example, a first output token 231a (e.g., <task_in_progress> 231) indicating a task progress state generated by the embodied multi-modal transformer 340, a second output token 232 a (e.g., <task_success> 232) indicating a task success state, and a third output token (e.g., <task_failure> 233) indicating a task failure state are illustrated.

The embodied multi-modal transformer 340 may generate policy monitoring output tokens (e.g., <task_in_progress> 231, <task_success> 232, <task_failure> 233) to perform online task planning on streaming data.
i) When it is determined that a policy for performing a current task is successful, the <task_success> 232 token may be generated, and reasoning and policy generation for the next task may be performed.
ii) When it is determined that a policy for performing a current task has failed, the <task_failure> 233 token may be generated, and reasoning about the current task failure and generation of a modified policy may be performed.
iii) When a current task is still in progress, the <task_in_progress> 231 token may be generated, and streaming data may be monitored until the <task_success> 232 token or the <task_failure> 233 token is generated.

In an example, vision-language action (VLA) may be a function that combines vision and language information to generate specific action instructions related to a goal of a task. For example, when a task goal such as “Wash carrots” is set as reasoning and policy step 341a, detailed tasks may be performed based on the goal using visual information and language instructions.

In an example, reinforcement learning (RL) may be a function that uses reinforcement learning algorithms to generate an optimal policy that increases the probability of success in a task. For example, the action of picking up a carrot and moving the carrot to the correct location may be optimized.

In an example, the embodied multi-modal transformer 340 may observe the successful completion of “wash carrots” and begin a next task of “peel carrots” as illustrated using a dexterous RL policy.

In an example, diffusion policy (DIFF) may be a function that naturally connects successive task steps to compensate for the failure of a task or generate a modified task plan. For example, when a “Prepare pan” task fails (i.e., reasoning and policy step 341b), DIFF may adjust the location of the pan or suggest a new approach in reasoning and policy step 341c.

In an example, as illustrated in FIG. 5, after the “peel carrot” command was replaced by a “prepare pan” VLA, a failure could be observed in the “put pan on the stove” task, where the embodied multi-modal transformer 340 may observe that the preparing of the pan failed (i.e., cannot be completed). In response, thereto (e.g., a struggle to perform the policy), the embodied multi-modal transformer 340 may request a rephrasing of the policy or initiate a different task.

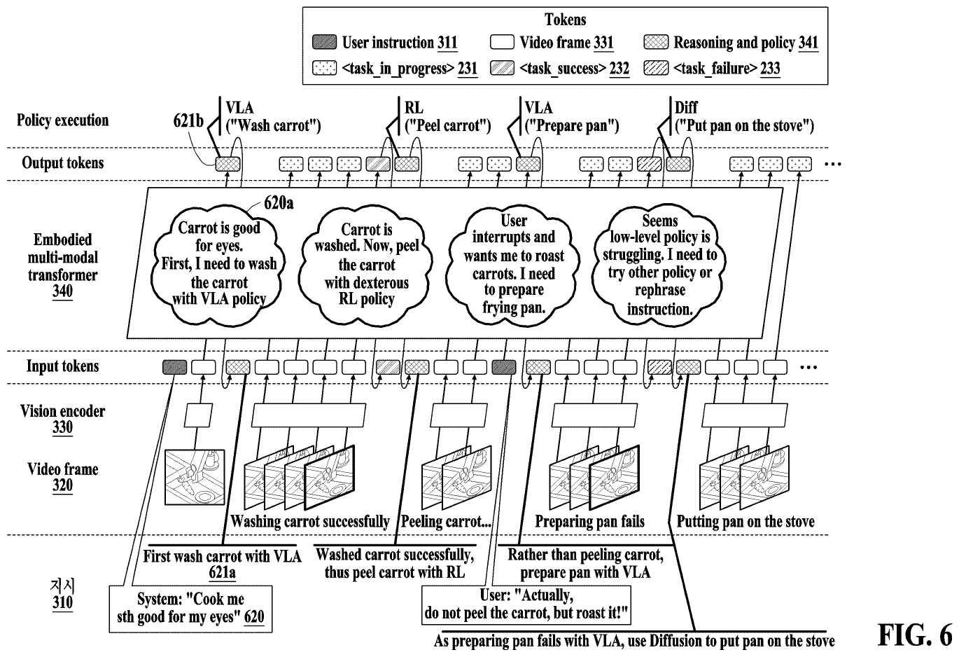

Referring to FIG. 6, in a non-limiting example, the overall input and output configuration of the embodied multi-modal transformer 340 is illustrated. To efficiently utilize the limited context window of the embodied multi-modal transformer 340, the <task_in_progress> 231 token may not be used as an auto-regressive input. Significant tokens that indicate the end of a task, such as <task_success> 232 or <task_failure> 233 may be used as an auto-regressive input. Task end state tokens such as <task success> 232 and <task failure> 233 may be used as an auto-regressive input to support reasoning and policy generation for the next task. On the other hand, the <task_in_progress> 231 token may indicate the progress state of the task, but may be considered relatively redundant information and thus may not be used as an autoregressive input.

For example, the input tokens illustrate a user instruction 610 to “cook me something good for my eyes” to which a reasoning and policy step 640a response is a VLA of “wash carrot” as the embodied multi-modal transformer 340 determines that carrots satisfy the user instruction 610 and determines the next step is to wash the carrots with an appropriate VLA in reasoning and policy step 621a. Thus, output token 621b of “wash carrot” is provided as a reasoning and policy step.

Additionally, when the sequence of encoded tokens (e.g., the video frame tokens 331) in streaming data observations is very long, token compression techniques that may be utilized depending on the modality may be applied. The vision encoder 330 may efficiently manage the sequence by applying various token compression techniques for each modality. For example, redundant information in the video frame 320 data may be removed or compressed to retain only information essential to the task.

FIG. 7 illustrates an example electronic device according to one or more embodiments.

The description referring to FIGS. 1 to 6 may also be applied to FIG. 7, and a repeated discussion thereof may be omitted.

Referring to FIG. 7, in a non-limiting example, the electronic device 700 may include a processor 730, a memory 750, and an output device 770 (e.g., a display). The processor 730, the memory 750, and the output device 770 may be connected to each other via a communication bus 705. The electronic device 700 may include the processor 730 configured to perform at least one method or an algorithm corresponding to at least one method described above for an operation of the electronic device 700.

The output device 770 may display a task progress result provided by the processor 730. The output device 770 may be the same device as a display included in the electronic device 700. In addition, the output device 770 may be embedded in the electronic device 700 to display a task progress result, or may be an external display device.

The display device 700 may be implemented using a liquid crystal display (LCD), a light-emitting diode (LED) display, a plasma display panel (PDP), a screen, a terminal, or any other type of display configured to display the images and information to be displayed by the image display apparatus. A screen may be a physical structure that includes one or more hardware components that provide the ability to render a user interface and receive user input. The screen may include any combination of a display region, a gesture capture region, a touch-sensitive display, and a configurable area. The screen may be part of an apparatus, or may be an external peripheral device that is attachable to and detachable from the apparatus. The display may be a single-screen display or a multi-screen display. A single physical screen may include multiple displays that are managed as separate logical displays permitting different content to be displayed on separate displays even though they are part of the same physical screen.

The memory 750 may store data related to an online task planning method performed by the processor 730. In addition, the memory 750 may store various pieces of information generated during the processing of the processor 730 described above. In addition, the memory 750 may store various data and programs. The memory 750 may include volatile memory or nonvolatile memory. The memory 750 may include a mass storage medium such as a hard disk to store various data.

Additionally, the processor 730 may perform at least one method or an algorithm corresponding to at least one method described above with reference to FIGS. 1 to 7. In the above-described process, the processor 730 may be a hardware-implemented data processing device having a circuit that is physically structured to execute desired operations.

The memory 750 may include computer-readable instructions. The processor 730 may be configured to execute computer-readable instructions, such as those stored in the memory 750, and through execution of the computer-readable instructions, the processor 730 is configured to perform one or more, or any combination, of the operations and/or methods described herein. The memory 750 may be a volatile or nonvolatile memory.

The processor 730 may be configured to execute programs or applications to configure the processor 730 to control the electronic apparatus 700 to perform one or more or all operations and/or methods involving the resolution of a deadlock state and resuming a task, and may include any one or a combination of two or more of, for example, a central processing unit (CPU), a graphics processing unit (GPU), or a neural network processing unit (NPU). The hardware-implemented electronic device 700 may include, for example, a microprocessor, a CPU, a processor core, a multi-core processor, a multiprocessor, an application-specific integrated circuit (ASIC), and a field programmable gate array (FPGA).

The neural networks, electronic devices, robots, sensors, agents, real-time embodied agent 200, embodied multi-modal transformer 210, sensors 212, vision encoder 330, embodied multi-modal transformer 340, electronic device 700, processor 730, memory 750, and output device 770 described herein and disclosed herein described with respect to FIGS. 1-7 are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-7 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method, the method comprising:
analyzing an environment state responsive to an input and receiving streaming data;
generating a task policy in response to the input and the analyzing of the environment state;
monitoring a state of the task being performed according to the task policy to output tokens indicating the state of the task; and
modifying the task policy based on the tokens,
wherein the task is performed according to the task policy as an overall task process by continuously collecting data generated while the task is in progress and continuously outputting tokens related to the state of the task from the monitoring.

2. The method of claim 1, wherein the analyzing of the environment state comprises:
outputting input tokens using a large language model (LLM) and one or more preprocessing models.

3. The method of claim 1, wherein the outputting of the tokens indicating the state of the task comprises:
outputting any one or any combination of a first output token indicating a task in progress state, a second output token indicating a task success state, and a third output token indicating a task failure state, through a multi-modal transformer.

4. The method of claim 3, further comprising:
in response to the first output token being output, continuously monitoring the streaming data until meaningful progress on the task is observed.

5. The method of claim 3, further comprising:
in response to the second output token being output, updating the task policy to establish a next task plan.

6. The method of claim 3, further comprising:
in response to the third output token being output, analyzing a cause of failure and modifying the task policy based on the analyzing of the cause of failure.

7. The method of claim 6, further comprising:
in response to the modifying of the task policy according to the cause of failure indicating that the task cannot be completed, transmitting a notification requesting additional instructions.

8. The method of claim 1, wherein the modifying of the task policy comprises performing reasoning and generating a low-level policy based on the tokens.

9. The method of claim 2, wherein the preprocessing model comprises a vision encoder configured to process any one or any combination of RGB, depth, and LIDAR data in the streaming data.

10. The method of claim 1, wherein the performing of the overall task process comprises:
analyzing a progress state of the task recursively and analyzing, in real time, a process for the progress of the task, a success of the task, and a failure of the task.

11. The method of claim 1, wherein the modifying the task policy comprises:
generating a new task policy based on the tokens, wherein the new task policy is created in response to one or more of detecting a task failure state, dynamic environmental changes, receiving override instructions, and optimizing task execution based on the continuously collecting of data.

12. An electronic device, comprising
processors configured to execute instructions; and
a memory storing the instructions, wherein execution of the instructions configures the processors to:
generate a task policy in response to an input and an analysis of an environmental state;
monitor a state of a task performed according to the task policy to output tokens indicating the state of the task; and
modify the task policy based on the tokens,
wherein the task is performed according to the task policy as an overall task process by continuously collecting data generated while the task is in progress and continuously outputting tokens related to the state of the task from the monitoring.

13. The electronic device of claim 12, wherein the processors are further configured to:
output any one or any combination of a first output token indicating a task in progress state, a second output token indicating a task success state, and a third output token indicating a task failure state, through a multi-modal transformer.

14. The electronic device of claim 13, wherein the processors are further configured to: in response to the first output token being output, continuously monitor the continuously collecting of data until meaningful progress on the task is observed.

15. The electronic device of claim 13, wherein the processors are further configured to:
in response to the second output token being output, update the task policy to establish a next task plan.

16. The electronic device of claim 13, wherein the processors are further configured to:
in response to the third output token being output, analyze a cause of failure and modifying the task policy based on the analysis result.

17. The electronic device of claim 16, wherein the processors are further configured to:
in response to the modifying of the task policy according to the cause of failure indicating that the failed task cannot be completed, transmitting a notification requesting additional instructions.

18. The electronic device of claim 13, wherein outputting the tokens is performed by a large language model and one or more preprocessing models, and
wherein the one or more preprocessing models comprise a vision encoder configured to process any one or any combination of RGB, depth, and LIDAR data in streaming data of the analysis of the environmental state.

19. The electronic device of claim 12, wherein the processors are further configured to:
perform reasoning and generate a low-level policy based on the tokens.

20. The electronic device of claim 12, wherein the modifying the task policy further comprises:
generating a new task policy based on the tokens, wherein the new task policy is created in response to one or more of detecting a task failure state, dynamic environmental changes, receiving override instructions, and optimizing task execution based on the continuously collecting of data.
